(19) United States
(12) Patent Application Publication
(10) Pub. No.: US 2008/0081241 A1
(43) Pub. Date: Apr. 3, 2008

(54) Liquid cartridge for storing liquid, electricity generating apparatus which generates electricity by liquid supplied from the liquid cartridge, and electronic device having the electricity generating apparatus as an electricity supply source

(75) Inventors: Daisuke Imanaka, Kawagoe-shi (JP); Yasunari Kabasawa, Hanno-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD., Tokyo (JP)

(21) Appl. No.: 11/904,087

(22) Filed: Sep. 26, 2007

(30) Foreign Application Priority Data
Sep. 29, 2006 (JP) 2006-267997

(51) Int. Cl. H01M 8/04

(52) U.S. Cl. 429/34

(57) ABSTRACT

Disclosed is a liquid cartridge, including: a storing section to store liquid; an electroosmosis material to send the liquid, which is provided in a discharging section through which the liquid in the storing section is discharged; an electrode to drive the electroosmosis material; and an end partition to partition the storing section at an end of the liquid so as to cover the end and to follow the end of the liquid.

### BACKGROUND OF THE INVENTION

1. Field of the Invention

The present invention relates to a liquid cartridge for storing liquid, an electricity generating apparatus which generates electricity by liquid supplied from the liquid cartridge and an electronic device having the electricity generating apparatus as an electricity supply source.

2. Description of the Related Art

It is generally known that in fuel cells used in portable devices, in order to supply fuel, a fuel cartridge into which fuel is encapsulated is connected to a fuel cell main body as shown in Japanese Patent Application Laid-open No. 2003-77505. A porous body (porous material) is charged in the fuel cartridge, fuel is held in the porous body and the fuel cartridge has a supply passage for supplying fuel to a fuel cell main body by a capillary force from the porous body.

In such a fuel cell system, if a diaphragm type liquid pump is used for supplying fuel, pulsation is prone to be generated and chemical reaction is adversely affected.

An electroosmotic flow pump using an electroosmosis phenomenon is used as the liquid pump in some cases. The electroosmotic flow pump includes an electroosmosis material charged in a tube, an electrode disposed upstream side of the electroosmosis material and an electrode disposed downstream side of the electroosmosis material. The electroosmosis material is made of dielectric such as silica fiber disposed in a flowing direction of the tube. Application of such an electroosmotic flow pump can surpress generation of pulsation. However, if the electroosmotic flow pump is used, no driving force is obtained unless electrodes are in contact with liquid fuel. Hence, in order to keep the liquid fuel always contacting with the electrode, a passage where liquid-suction material is charged up to the electroosmotic flow pump is necessary. When the electroosmotic flow pump is placed inside the fuel cell main body, a passage including the liquid-suction material is also necessary inside the device.

FIG. 6 is a schematic side sectional view of a state where a liquid-suction material 304 is disposed to be in contact with an electroosmotic flow pump 302 disposed in a fuel introducing section 301 in a device 300 including a fuel cell, and the liquid-suction material 304 in the fuel introducing section 301 is connected to the fuel cartridge 305. If the electroosmotic flow pump 302 is disposed in the device 300 in such manner, the liquid-suction material 304 is required for introducing fuel 10 from the fuel cartridge 305. Therefore, there is a problem that a structure of the device 300 becomes complicated. In FIG. 6, a symbol 10 represents fuel, a symbol 303 represents an electroosmosis material and symbols 303a and 303b each represents an electrode.

FIG. 7 shows a structure in which the above-described liquid-suction material 304 is not provided and the electroosmotic flow pump 302 is exposed from the device 300. However, this structure has a problem that repeated connection/disconnection between the electroosmotic flow pump 302 and the fuel cartridge 305 causes, the electroosmotic flow pump 302 to be damaged by a mechanical load caused and the electroosmotic flow pump 302 is prone to be deteriorated by contamination. In FIG. 7, the same constituent members as those in FIG. 6 are designated with the same symbols.

When the electroosmotic flow pump 302 is disposed in the device 300 as shown in FIG. 6, there is a problem that since the electroosmotic flow pump 302 can not easily be exchanged, even when the electroosmotic flow pump 302 is contaminated which will cause deterioration, output is not easily restored by exchanging the electroosmotic flow pump 302.

### SUMMARY OF THE INVENTION

Hence, it is a main object of the present invention to provide a liquid cartridge, an electricity generating apparatus and an electronic device which are suitable for utilizing an electroosmotic flow pump.

According to a first aspect of the present invention, there is provided a liquid cartridge, comprising:

a storing section to store liquid;

an electroosmosis material to send the liquid, which is provided in a discharging section through which the liquid in the storing section is discharged;

an electrode to drive the electroosmosis material; and

an end partition to partition the storing section at an end of the liquid so as to cover the end and to follow the end of the liquid.

According to a second aspect of the present invention, there is provided a liquid cartridge, comprising:

a storing section to store liquid;

an electroosmosis material to send the liquid, which is provided in a discharging section through which the liquid in the storing section is discharged;

an electrode to drive the electroosmosis material; and

a liquid-suction material to introduce the liquid to the electroosmosis material, which is provided on an inner wall surface continuously such that the liquid is in contact with the liquid-suction material irrespective of direction of the storing section with respect to a gravity direction and on the discharging section such that the liquid-suction material is in contact with the electroosmosis material.

According to a third aspect of the present invention, there is provided a liquid cartridge, comprising:

a storing section to store liquid;

an electroosmosis material to send the liquid, which is provided in a discharging section through which the liquid in the storing section is discharged;

an electrode to drive the electroosmosis material; and

a liquid-suction material to introduce the liquid to the electroosmosis material, which is provided over an entire inner wall surface of the storing section and on the discharging section such that the liquid-suction material is in contact with the electroosmosis material.

According to a fourth aspect of the present invention, there is provided a liquid cartridge, comprising:

a storing section to store liquid;

an electroosmosis material to send the liquid, which is provided in a discharging section through which the liquid in the storing section is discharged;

an electrode to drive the electroosmosis material, and

a liquid-suction material to introduce the liquid to the electroosmosis material, which includes a deformable section deformable by gravity having a length extending from the discharging section to a distal end of an inner wall of the storing section and which is provided on the discharging section such that the liquid-suction material is in contact with the electroosmosis material.

### BRIEF DESCRIPTION OF THE DRAWINGS

The above and further objects, features and advantages of the present invention will become more apparent from the following detailed description taken in conjunction with the accompanying drawings and are explanatory only, and thus are not intended as a definition of the limits of the present invention, and wherein;

FIG. 1 is a side sectional view of a fuel cartridge 1 according to a first embodiment taken along a longitudinal direction thereof;

FIG. 2 is a block diagram showing a basic structure of an electricity generating apparatus 200;

FIG. 3 is a side sectional view of a fuel cartridge 3 according to a second embodiment taken along a longitudinal direction thereof;

FIG. 4 is a side sectional view of a fuel cartridge 6 according to a third embodiment taken along a longitudinal direction thereof;

FIG. 5 is a side sectional view of a fuel cartridge 8 according to a fourth embodiment taken along a longitudinal direction thereof;

FIG. 6 is a schematic side sectional view showing a conventional example of a connecting structure between a fuel cartridge 305 and a device 300; and

FIG. 7 is a schematic side sectional view showing a conventional example of another connecting structure between a fuel cartridge 305 and a device 300.

### DESCRIPTION OF THE PREFERRED EMBODIMENTS

The best mode for carrying out the present invention will be explained below with reference to the drawings. Various technically preferable limitations for carrying out the invention are added to the following embodiments, but the scope of the invention is not limited to the embodiments and illustrated examples.

### First Embodiment

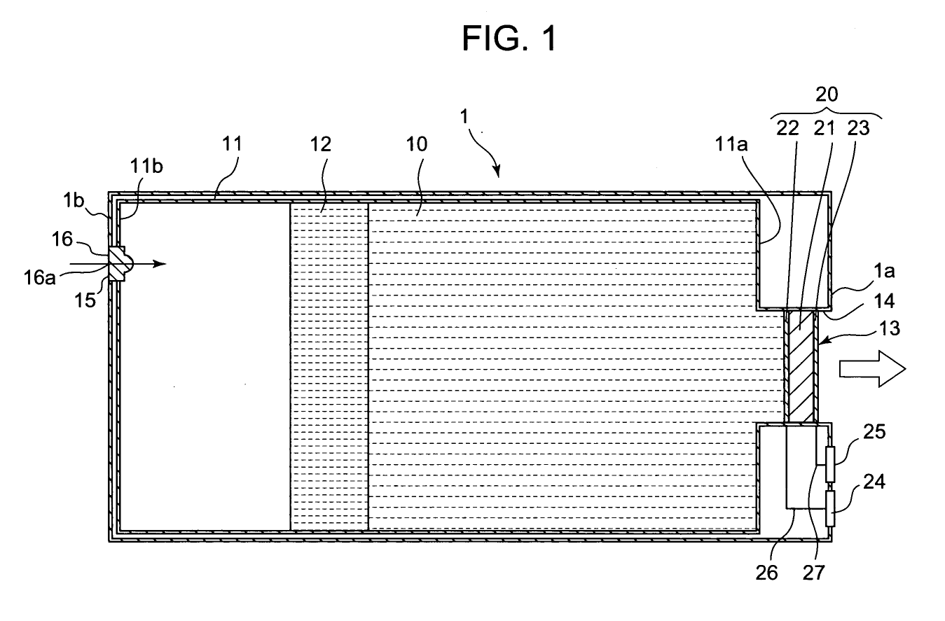

FIG. 1 is a side sectional view of a fuel cartridge 1 according to the first embodiment taken along a longitudinal direction thereof.

The fuel cartridge 1 is for example, a square prism body having a hollow fuel storing section 11 inside and fuel 10 is stored in the fuel storing section 11. The fuel 10 is chemical fuel, or mixture of chemical fuel and water. A chemical compound including hydrogen element, for example, alcohols such as methanol and ethanol, or gasoline can be used as the chemical fuel.

An end partition 12 is accommodated in the fuel storing section 11 such that the end partition 12 is in contact with an end of the fuel 10. The fuel storing section 11 is partitioned by the end partition 12 into a region where the fuel 10 is stored and a region where the fuel 10 is not stored. The end partition 12 is liquid having high viscosity and it is preferable that the end partition 12 has characteristics of structure viscosity fluid (abnormal viscosity fluid) in which apparent stress whose deviation stress (or deviation speed) is increased appears. Concretely, polybutene, liquid paraffin, spindle oil, other mineral oil, dimethyl silicon oil, methylphenyl silicon oil, other silicon oil and a combination thereof may be used as the end partition 12. If fuel 10 approaches a later-described fuel discharge opening 14 by the end partition 12, the end partition 12 follows so that no gap is created between the end of the fuel 10 and the end partition 12. Therefore, the fuel 10 can easily be discharged out and it is possible to suppress volatilization of the fuel 10.

The fuel cartridge 1 is a transparent or translucent member and is made of material such as polyethylene, polypropylene, polycarbonate or acrylic material.

A fuel discharging section 13 is formed at a central position of a front surface 1a of the fuel cartridge 1 in its longitudinal direction. The fuel discharging section 13 penetrates the front surface 1a and penetrates a front surface 11a of the fuel storing section 11 corresponding to the former penetrating portion so that the fuel discharging section 13 is brought into communication with the fuel storing section 11. Fuel 10 is discharged through the fuel discharging section 13.

A fuel discharge opening 14 is formed in the fuel discharging section 13. The fuel discharge opening 14 is a through hole through which fuel 10 in the fuel storing section 11 is discharged out. The electroosmotic flow pump 20 is disposed in the fuel discharge opening 14. The electroosmotic flow pump 20 has an electroosmosis material 21 which is formed into a disk-like shape and fitted into the fuel discharge opening 14. The electroosmosis material 21 is formed at its both surfaces with electrodes 22 and 23 so that voltage is applied therebetween. The electrodes 22 and 23 are respectively connected to electrode terminals 24 and 25 through wires 26 and 27. The electrode terminals 24 and 25 are formed below the fuel discharge opening 14 on the front surface 1a of the fuel cartridge 1. The wires 26 and 27 are disposed in a wall of the fuel cartridge 1. Porous material, fiber material or particle filler is used as the electroosmosis material 21 and silica fiber material is used as one example. The electrodes 22 and 23 can be formed by vapor deposition for example.

An outside air communication opening 15 is formed at a back surface 11b of the fuel storing section 11 in its longitudinal direction at its upper location. The outside air communication opening 15 penetrates the back surface 11b and penetrates a back surface 1b of the fuel cartridge 1 corresponding to the former penetrating portion, thereby bringing outside air and the fuel storing section 11 into communication with each other. A check valve 16 is fitted to the outside air communication opening 15 for preventing air from being discharged out from the fuel storing section 11 unnecessarily.

Concretely, the check valve 16 is a duckbill valve formed into a duckbill shape with a material having flexibility and elasticity. The check valve 16 is fitted into the outside air communication opening 15 in a state where a tip end of the duckbill shape is oriented inward of the fuel storing section 11. Examples of the material having flexibility and elasticity are ethylene propylene diene monomer rubber (EPDM) and butyl rubber. Generally, butyl rubber shows low gas permeability among elastic material having high polymer and thus, in order to form a smaller part, it is practically preferable to select the butyl rubber. Since the check valve 16 does not have a mechanically complicated structure, a volume and cost thereof can be reduced.

The check valve 16 is provided with a communication hole 16a through which inside and outside of the fuel storing section 11 are in communication with each other. The communication hole 16a is designed such that the check valve 16 applies a force in a direction for closing the communication hole 16a around the communication hole 16a by an internal pressure of the fuel storing section 11. If an amount of the fuel 10 stored in the fuel storing section 11 is reduced in the fuel storing section 11, a negative pressure is generated. The communication hole 16a is designed such that air from outside of the fuel storing section 11 enters through the communication hole 16a so as to buffer a pressure difference between inside and outside of the fuel storing section 11 in accordance with the negative pressure.

Therefore, if the fuel cartridge 1 is connected to the device main body such as a later-described electricity generating section 100 and the fuel 10 reliably comes into contact with the electroosmosis material 21 due to the end partition 12. The fuel 10 is absorbed by the electroosmosis material 21 with which the fuel 10 is in contact by means of the capillary force. If voltage having appropriate orientation is applied between the electrodes 22 and 23, the fuel 10 in the electroosmosis material 21 flows from the electrode 22 toward the electrode 23 and the fuel 10 exudes to outside of the electroosmosis material 21 from the electrode 23. With this, flow of fuel 10 is generated and the fuel 10 is sent to the electricity generating section 100. If the dielectric of the electroosmosis material 21 comes into contact with the fuel 10 and the dielectric is negatively charged and the fuel 10 is positively charged, voltage is applied so that potential of the electrode 22 becomes higher than that of the electrode 23. If the dielectric of the electroosmosis material 21 comes into contact with the fuel 10 and the dielectric is positively charged and the fuel 10 is negatively charged, voltage is applied so that potential of the electrode 23 becomes higher than that of the electrode 22. If fuel 10 is discharged from the fuel storing section 11, the volume of the fuel 10 in the fuel storing section 11 is reduced. With this reduction in volume, the pressure in the fuel storing section 11 is reduced, the check valve 16 is opened and air enters the fuel storing section 11 from the check valve 16. The pressure in the fuel storing section 11 is reduced in this manner and a case in which the fuel 10 is not easily sent from the fuel cartridge 1 is prevented.

Next, the electricity generating apparatus 200 having the fuel cartridge 1 will be explained.

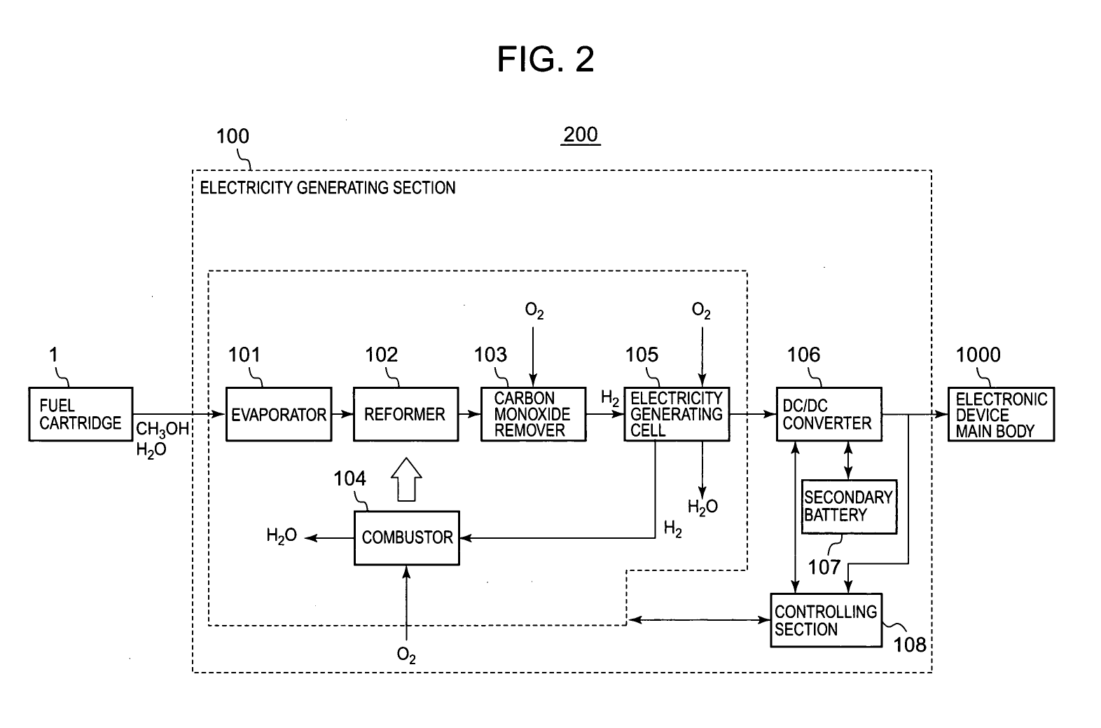

FIG. 2 is a block diagram showing a basic structure of the electricity generating apparatus 200.

The electricity generating apparatus 200 includes the fuel cartridge 1 in which fuel 10 is stored and the electricity generating section 100 which generates electric energy from the fuel 10 supplied from the fuel cartridge 1. The electricity generating section 100 includes a evaporator 101, a reformer 102, a carbon monoxide remover 103, a combustor 104, an electricity generating cell 105, a DC/DC converter 106, a secondary battery 107 and a controlling section 108.

As described above, if fuel 10 is supplied to the evaporator 101 of the electricity generating section 100 from the fuel discharging section 13 of the fuel cartridge 1, the fuel 10 is evaporated by the evaporator 101. The fuel 10 evaporated by the evaporator 101 is sent to the reformer 102. In the reformer 102, hydrogen and carbon dioxide are generated by a reforming reaction catalyst from air-fuel mixture of fuel 10 supplied from the evaporator 101 and an extremely small amount of carbon monoxide is also produced. When mixture liquid in the fuel cartridge 1 is mixture liquid of methanol and water, catalyst reaction as shown in the following chemical equations (1) and (2) occurs in the reformer:

CH₃OH+H₂O→3H₂+CO₂ (1)

H₂+CO₂→H₂O+CO (2)

The air-fuel mixture produced in the reformer 102 is mixed with air supplied to the carbon monoxide remover 103. In the carbon monoxide remover 103, carbon monoxide gas in the air-fuel mixture is preferentially oxidized (burned) by selected oxidizing reaction catalyst as shown in the following chemical equation (3) and the carbon monoxide is removed.

2CO+O₂→2CO₂ (3)

Hydrogen gas is included in the air-fuel mixture in the state where the carbon monoxide is removed and the air-fuel mixture is supplied to a fuel electrode of the electricity generating cell 105. Air is supplied to the oxygen electrode from outside, hydrogen in the air-fuel mixture is electric chemical reacted with oxygen in air supplied to the oxygen electrode through an electrolyte film and electric energy is generated between the fuel electrode and the oxygen electrode.

When the electrolyte film is a hydrogen ion permeable electrolyte film (e.g., solid high polymer electrolyte film), a reaction as shown in the following chemical equation (4) occurs in the fuel electrode, hydrogen ion produced in the fuel electrode passes through the electrolyte film and a reaction as shown in the following chemical equation (5) occurs in the oxygen electrode.

H₂→2H⁺+2e⁻ (4)

2H⁺+1/2O₂+2e⁻→H₂O (5)

The DC/DC converter 106 converts electric energy generated by the electricity generating cell 105 to appropriate voltage and then supplies the same to the electronic device main body 1000. The DC/DC converter 106 also puts the secondary battery 107 on charge using electric energy generated by the electricity generating cell 105 and when the electricity generating cell 105 is not operated, the DC/DC converter 106 supplies electric energy to the electronic device main body 1000 from the secondary battery 107. The controlling section 108 controls pumps, valves, heaters (all above elements are not shown), the DC/DC converter 106 and the like which are necessary to operate the evaporator 101, the reformer 102, the carbon monoxide remover 103, the combustor 104 and the electricity generating cell 105, and controls so that electric energy is stably supplied to the electronic device main body 1000.

After fuel 10 is supplied to the electricity generating section 100 from the fuel discharging section 13 of the fuel cartridge 1 and electric energy is generated. The electronic device main body 1000 connected to the electricity generating apparatus 200 is driven by the generated electric energy.

As described above, according to the first embodiment, the fuel cartridge 1 includes the fuel storing section 11, the electroosmosis material 21 which is provided in the fuel discharging section 13 of the fuel storing section 11 for sending fuel 10, the electrodes 22 and 23, and the electroosmotic flow pump 20 is provided in the fuel cartridge 1. When the electroosmotic flow pump is provided in the device in a section such as the electricity generating section, it is necessary that the liquid-suction material for introducing fuel to the electroosmotic flow pump is provided in the electricity generating section, but according to the present invention, it is only necessary to provide the end partition 12 in the fuel storing section 11 and the structure of the electricity generating section 100 does not become complicated. Further, as compared with the conventional case in which the electroosmotic flow pump is provided such that it is exposed from the device such as the electricity generating section, it is possible to prevent damage caused by mechanical load which is caused by repeating the connection/disconnection between the electroosmotic flow pump 20 and the fuel cartridge 1, and it is possible to prevent deterioration of the electroosmotic flow pump 20 caused by contamination. Further, the electroosmotic flow pump 20 can be replaced by new one when the fuel cartridge 1 is replaced by new one. Therefore, it is possible to easily restore the output reduction caused by deterioration of the electroosmotic flow pump 20.

Since the end partition 12 is provided in the fuel storing section 11, the end partition 12 follows as the fuel 10 is reduced and the fuel 10 can always be in contact with the electroosmosis material 21. Therefore, the capillary force impregnates the electroosmotic flow pump 20 with fuel 10 and the fuel 10 can reliably be sent from the fuel cartridge 1 irrespective of direction of the fuel cartridge 1 with respect to a gravity direction by output controlled by the electricity generating section 100.

It is preferable that since the volume of the end partition 12 need not be large, it is unnecessary to largely reduce the volume of the fuel 10 of the fuel storing section 11.

### Second Embodiment

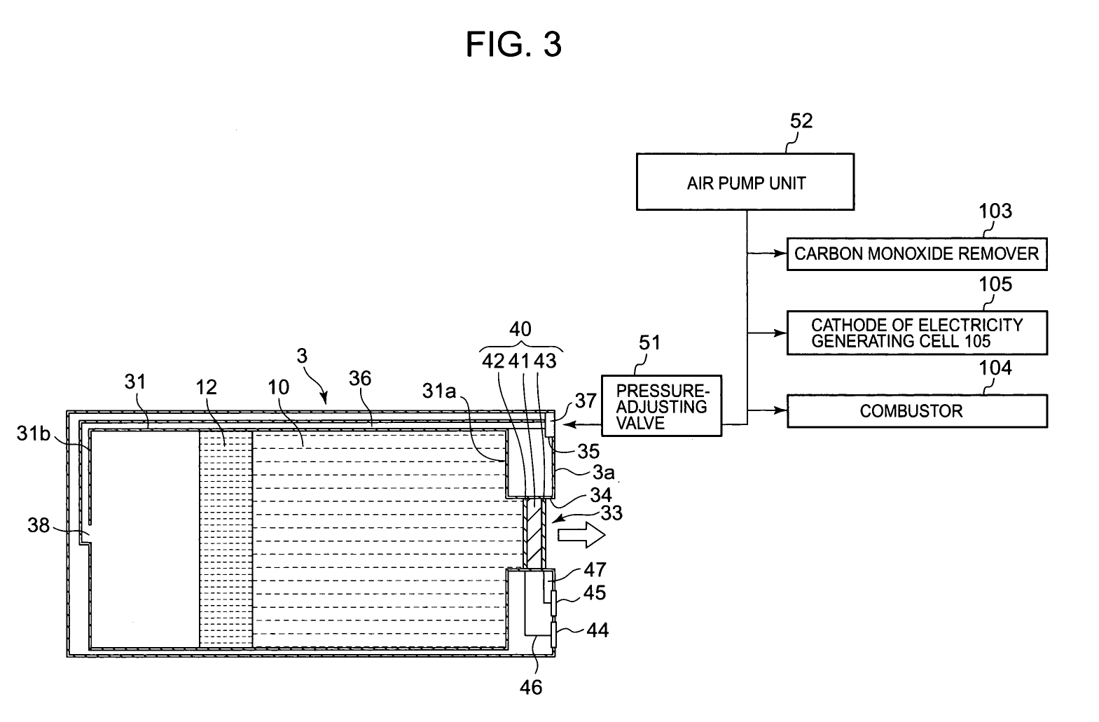

FIG. 3 is a side sectional view of a fuel cartridge 3 according to a second embodiment taken along a longitudinal direction thereof.

In the fuel cartridge 1 of the first embodiment, fuel 10 is sent out by a driving force of the electroosmotic flow pump 20 only. In the fuel cartridge 3 of the second embodiment, a structure for sending the fuel 10 under pressure by sending air from the back surface of the fuel is added.

The fuel cartridge 3 is for example, a square prism body having a hollow fuel storing section 31 and fuel 10 is stored in the fuel storing section 31. The same end partition 12 as that of the first embodiment is accommodated in the fuel storing section 31 such that the end partition 12 is in contact with an end of the fuel 10. A fuel discharging section 33 is formed at a central position of a front surface 3a of the fuel cartridge 3 in its longitudinal direction. The fuel discharging section 33 penetrates the front surface 3a and also penetrates a front surface 31a of the fuel storing section 31 corresponding to the former penetrating portion, and the fuel discharging section 33 is in communication with the fuel storing section 31 and discharges fuel 10.

The fuel discharging section 33 is formed with a fuel discharge opening 34 which is a through hole through which fuel 10 in the fuel storing section 31 is discharged out. An electroosmotic flow pump 40 is disposed in the fuel discharge opening 34 and the electroosmotic flow pump 40 includes an electroosmosis material 41. The electroosmosis material 41 is similar to the above-described electroosmosis material 21. The electroosmosis material 41 is formed at its both surfaces with electrodes 42 and 43. The electrodes 42 and 43 are respectively connected to electrode terminals 44 and 45 formed on the front surface 3a of the fuel cartridge 3 through wires 46 and 47.

A pressurizing line introducing opening (carrying section 1) 35 is formed in the front surface 3a of the fuel cartridge 3 at a location above the fuel discharge opening 34. The pressurizing line introducing opening 35 is formed so as to penetrate the front surface 3a. A valve 37 is fitted to the pressurizing line introducing opening 35. An air pump unit (external pressurizing section) 52 is connected to the valve 37 through a pressure-adjusting valve 51. The air pump unit 52 sends air (pressurizing gas) to an air pressure sending passage (pressurizing line sending passage and carrying section 2) 36 under pressure. The air pressure sending passage 36 is in communication from the pressurizing line introducing opening 35 (gas sent into the pressurizing line may be for example, inert gas and it is not always necessary that the gas is air).

When it is used as the electricity generating apparatus 200 as in the above-described first embodiment, the air pump unit 52 is connected to the carbon monoxide remover 103, a cathode of the electricity generating cell 105 and the combustor 104 so that air can be supplied to the carbon monoxide remover 103, the cathode of the electricity generating cell 105 and the combustor 104. Therefore, the air pump unit 52 can commonly be used by them. The air pressure sending passage 36 straightly extends from the valve 37 along an outer upper surface of the fuel storing section 31 in a longitudinal direction of the fuel storing section 31 and the air pressure sending passage 36 is in communication with a pressurizing line communication opening 38 (carrying section 3) formed at a central position of a back surface 31b of the fuel storing section 31. Air which flows into the air pressure sending passage 36 from the air pump unit 52 through the pressure-adjusting valve 51 and the valve 37 is sent into the fuel storing section 31 under pressure. With this, the end partition 12 is pressurized from the back surface and the fuel 10 is pressurized toward the electroosmotic flow pump 40.

The pressurizing line introducing opening 35, the air pressure sending passage (pressurizing line sending passage) 36 and the pressurizing line communication opening 38 are the carrying sections which introduces air (pressurizing gas) sent by the air pump unit 52 into a direction opposite from the fuel 10 of the end partition 12 in the fuel storing section 31. The air pump unit 52 is the external pressurizing means.

Therefore, if the fuel cartridge 3 is connected to the device main body such as the above-mentioned electricity generating section 100, air is sent to the air pressure sending passage 36 from the air pump unit 52 through the pressure-adjusting valve 51 and then, air is sent under pressure into the fuel storing section 31 from the pressurizing line communication opening 38 through the air pressure sending passage 36 and the air pressurizes the end partition 12. This action assists the sending out operation of fuel 10 which is in contact with the electroosmosis material 41 and absorbed by the electroosmosis material 41. In this state, if voltage in an appropriate direction is applied between the electrodes 42 and 43, the fuel 10 in the electroosmosis material 41 flows toward the electrode 43 from the electrode 42 and the fuel 10 exudes to outside of the electroosmosis material 41 from the electrode 43. With this, flow of fuel 10 is generated and the fuel 10 is sent to the electricity generating section 100. If the dielectric of the electroosmosis material 41 comes into contact with the fuel 10 and the dielectric is negatively charged and the fuel 10 is positively charged, voltage is applied so that potential of the electrode 42 becomes higher than that of the electrode 43. If the dielectric of the electroosmosis material 41 comes into contact with the fuel 10 and the dielectric is positively charged and the fuel 10 is negatively charged, voltage is applied so that potential of the electrode 43 becomes higher than that of the electrode 42.

The fuel cartridge 3 can be used for the electricity generating apparatus as in the first embodiment. In this case, the electricity generating apparatus includes the electricity generating section 100 comprising the evaporator 101, the reformer 102, the carbon monoxide remover 103, the combustor 104, the electricity generating cell 105, the DC/DC converter 106, the secondary battery 107 and the controlling section 108, as in the first embodiment. Since the structure and the operation of the electricity generating section 100 are the same as those of the first embodiment, explanation thereof will be omitted.

According to the second embodiment, like the first embodiment, since the electroosmotic flow pump 40 is provided in the fuel cartridge 3, it is only necessary to provide the end partition 12 in the fuel storing section 11 and the structure of the electricity generating section 100 does not become complicated. Further, as compared with the conventional case in which the electroosmotic flow pump is provided such that it is exposed from the device such as the electricity generating section, it is possible to prevent damage caused by mechanical load which is caused by repeating the connection/disconnection between the electroosmotic flow pump and the fuel cartridge and it is possible to prevent deterioration of the electroosmotic flow pump 40 caused by contamination. Further, the electroosmotic flow pump 40 can be replaced by new one when the fuel cartridge 3 is replaced by new one. Therefore, it is possible to easily restore the output reduction caused by deterioration of the electroosmotic flow pump 40.

Since the end partition 12 is provided in the fuel storing section 31 and the end partition 12 follows as the fuel 10 is reduced and the fuel 10 can always be in contact with the electroosmosis material 21. Therefore, the capillary force impregnates the electroosmotic flow pump 40 with fuel 10 and the fuel 10 can reliably be sent from the fuel cartridge 3 irrespective of direction of the fuel cartridge 3 with respect to a gravity direction by output controlled by the electricity generating section 100.

Further, the fuel storing section 31 is formed with the pressurizing line communication opening 38. Air is sent under pressure from the air pump unit 52 through the pressure-adjusting valve 51 and the valve 37 of the pressurizing line introducing opening 35 and the air pressure sending passage 36 to the pressurizing line communication opening 38. Air under pressure is sent from the pressurizing line communication opening 38, therefore, the fuel 10 is pressurized from the back surface side and this can assist the driving operation of the electroosmotic flow pump 40. Since the flow rate of the pressurized fuel 10 can be adjusted by the electroosmotic flow pump 40, the flow rate can be changed in a stepless manner in an analog fashion by voltage. In this case, it is unnecessary to use a high precision valve as the pressure-adjusting valve 51. It is also possible to employ such a control that voltage is applied to the electroosmotic flow pump 40 in a direction opposite from that explained above and brake is applied by the electroosmotic flow pump 40 by sending air in the sending direction, thereby adjusting the flow rate.

It is preferable that since the volumes of the end partition 12, the air pressure sending passage 36 need not be large and it is unnecessary to largely reduce the volume of the fuel 10 of the fuel storing section 31.

Since the pressurizing line introducing opening 35 is disposed on the same side (front surface 3a) as the fuel discharge opening 34 of the fuel cartridge 3 and a structure of a connection interface section with respect to the device can be simplified.

### Third Embodiment

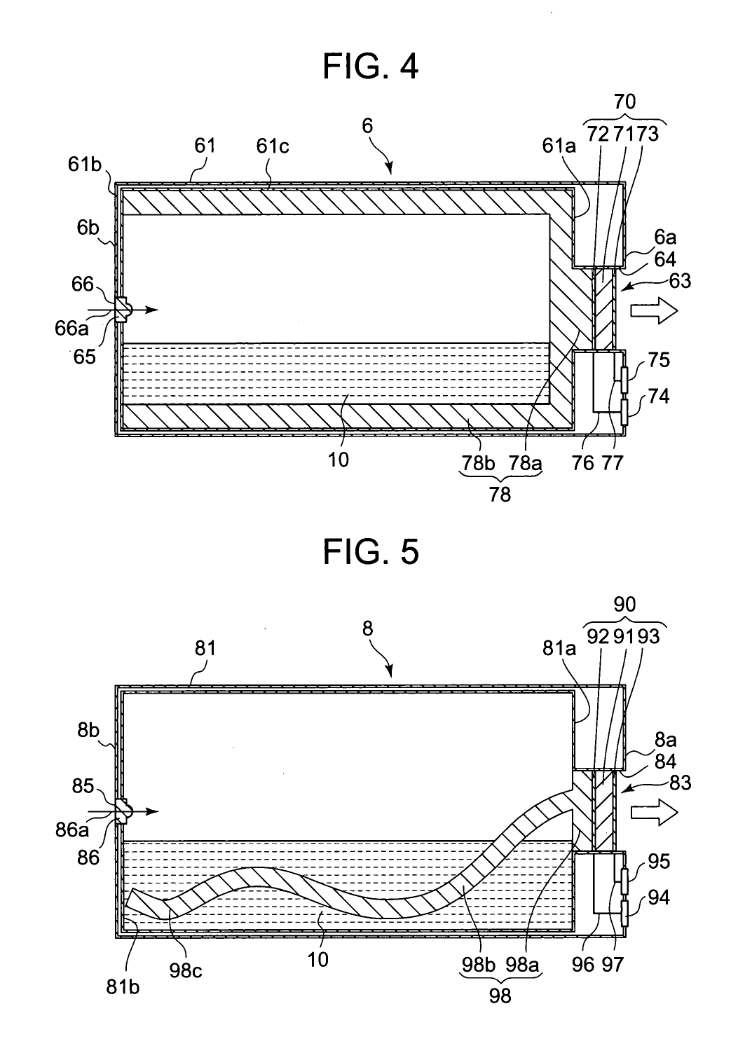

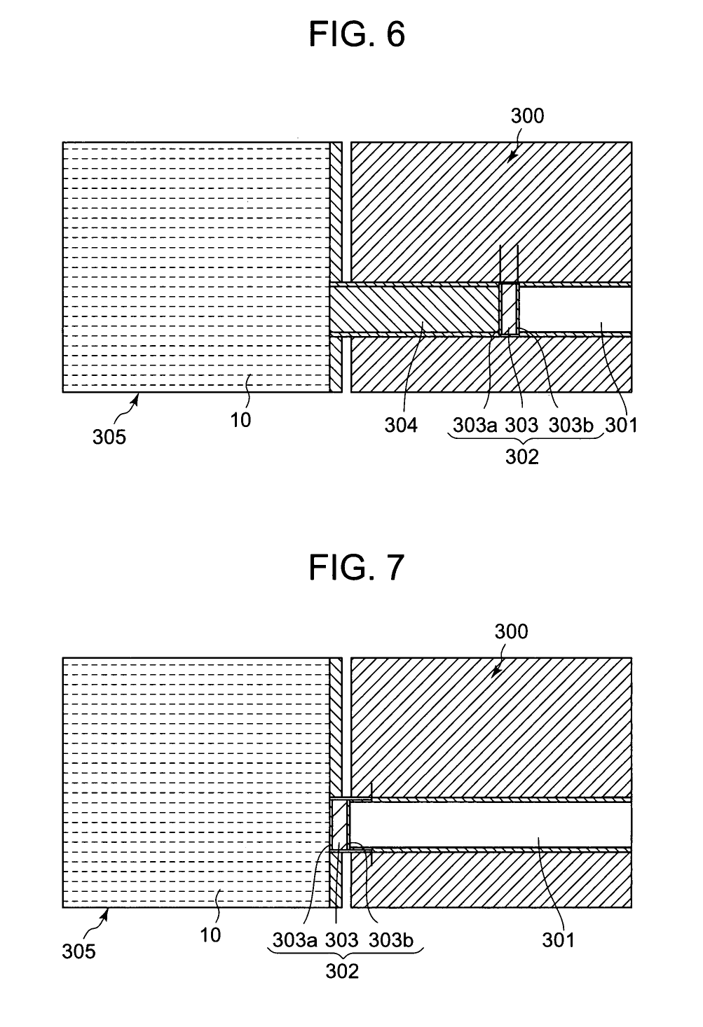

FIG. 4 is a side sectional view of a fuel cartridge 6 according to a third embodiment taken along a longitudinal direction thereof.

The third embodiment is different from the fuel cartridges 1 and 3 of the first and second embodiments in that the end partition 12 is not provided at the end of the fuel 10 in a fuel storing section 61.

The fuel cartridge 6 is for example a square prism body having a hollow fuel storing section 61 and fuel 10 is stored in the fuel storing section 61. A fuel discharging section 63 is formed at a central position of a front surface 6a of the fuel cartridge 6 in its longitudinal direction. The fuel discharging section 63 penetrates the front surface 6a and also penetrates a front surface 61a of the fuel storing section 61 corresponding to the former penetrating portion, and the fuel discharging section 63 is in communication with the fuel storing section 61 and discharges fuel 10.

A fuel discharge opening 64 is formed in the fuel discharging section 63. The fuel discharge opening 64 is a through hole through which fuel 10 in the fuel storing section 61 is discharged out. An electroosmotic flow pump 70 is disposed in the fuel discharge opening 64, and the electroosmotic flow pump 70 includes an electroosmosis material 71. The electroosmosis material 71 is the same as the electroosmosis material 21 of the above-described first embodiment. The electroosmosis material 71 is formed at its both surfaces with electrodes 72 and 73. The electrodes 72 and 73 are respectively connected to electrode terminals 74 and 75 through wires 76 and 77. The electrode terminals 74 and 75 are formed on a front surface 6a of the fuel cartridge 6. A liquid-suction material 78 is provided in the fuel discharge opening 64 such that the liquid-suction material 78 is in surface-contact with an electrode 72 of the electroosmosis material 71. As the liquid-suction material 78, it is possible to use a porous material such as sponge, felt, ceramic, resin, bunch of fiber of glass fiber or the like having capillary force. As a liquid absorbing ability, it is preferable that the liquid-suction material 78 is lyophilic with respect to fuel, and the density of the porous material is high, but it is necessary to appropriately determine the density while taking into account the balance of pressure loss when fuel is sent out.

The liquid-suction material 78 includes a disk portion 78a fitted to the fuel discharge opening 64, and a wall surface 78b provided so as to extend over the entire inner wall surface 61c of the fuel storing section 61 from the disk portion 78a. Since the liquid-suction material 78 has the wall surface 78b, fuel 10 can always be in contact with the wall surface 78b irrespective of direction of the fuel cartridge 6 with respect to the gravity direction (the liquid-suction material 78 covers the inner wall surface 61c of the fuel storing section 61 also in a direction perpendicular to a paper sheet of FIG. 4).

An outside air communication opening 65 is formed at a central position of a back surface 61b of the fuel storing section 61 in its longitudinal direction. The outside air communication opening 65 penetrates the back surface 61b, and also penetrates a back surface 6b of the fuel cartridge 6 corresponding to the former penetrating portion. The fuel storing section 61 is in communication with outside air through the outside air communication opening 65. A check valve 66 is fitted to the outside air communication opening 65. The check valve 66 prevents fuel 10 and air from being unnecessarily discharged out from the fuel storing section 61. The same duckbill valve as the check valve 16 of the first embodiment can be used as the check valve 66.

The check valve 16 is provided with a communication hole 66a through which inside and outside of the fuel storing section 61 are in communication with each other. The communication hole 66a is designed such that a force is applied to the check valve 66 in a direction in which the communication hole 66a is closed around the communication hole 66a by an internal pressure of the fuel storing section 61. Therefore, fuel 10 does not leak unnecessarily outside of the fuel storing section 61 from the communication hole 66a. If an amount of fuel 10 stored in the fuel storing section 61 is reduced in the fuel storing section 61, a negative pressure is generated. The communication hole 66a is designed such that air from outside of the fuel storing section 61 enters through the communication hole 66a so as to buffer a pressure difference between inside and outside of the fuel storing section 61 in accordance with the negative pressure.

FIG. 4 is illustrated such that a portion of 6b is not covered with the wall surface 78b of the liquid-suction material 78, but the entire portion 6b except the portion of the outside air communication opening 65 only may be covered with the wall surface 78b of the liquid-suction material 78.

Therefore, if the fuel cartridge 6 is connected to a device main body of the above-described electricity generating section 100 or the like, fuel 10 is absorbed by the liquid-suction material 78 and permeates the liquid-suction material 78 which is in contact with the fuel 10 and the liquid-suction material 78 is impregnated with fuel 10 by a capillary force. The fuel 10 which permeates the liquid-suction material 78 and is absorbed by the liquid-suction material 78 is also absorbed by the electroosmosis material 71 which is in contact with the fuel 10. If voltage in an appropriate direction is applied between the electrodes 72 and 73 in this state, fuel 10 in the electroosmosis material 71 flows from the electrode 72 to the electrode 73, and fuel 10 exudes to outside of the electroosmosis material 71 from the electrode 73. With this, flow of fuel 10 is generated and the fuel 10 is sent to the electricity generating section 100. If the dielectric of the electroosmosis material 71 comes into contact with the fuel 10 and the dielectric is negatively charged and the fuel 10 is positively charged, voltage is applied so that potential of the electrode 72 becomes higher than that of the electrode 73. If the dielectric of the electroosmosis material 71 comes into contact with the fuel 10 and the dielectric is positively charged and the fuel 10 is negatively charged, voltage is applied so that potential of the electrode 73 becomes higher than that of the electrode 72. If fuel 10 is discharged from the fuel storing section 61, the volume of the fuel 10 in the fuel storing section 61 is reduced. With this reduction in volume, the pressure in the fuel storing section 61 is reduced, the check valve 66 is opened and air enters the fuel storing section 61 from the check valve 66. The pressure in the fuel storing section 61 is reduced in this manner and a case in which the fuel 10 is not easily sent from the fuel cartridge 6 is prevented.

The fuel cartridge 6 can be used for the electricity generating apparatus like the first embodiment. In this case, the electricity generating apparatus includes the electricity generating section 100 comprising the evaporator 101, the reformer 102, the carbon monoxide remover 103, the combustor 104, the electricity generating cell 105, the DC/DC converter 106, the secondary battery 107 and the controlling section 108. Since the structure and the operation of the electricity generating section 100 are the same as those of the first embodiment, explanation thereof will be omitted.

According to the third embodiment, like the first embodiment, the electroosmotic flow pump 70 is provided in the fuel cartridge 6. Therefore, it is only necessary to provide the liquid-suction material 78 on the fuel discharging section 63 such that the liquid-suction material 78 is in surface-contact with the electrode 72 of the electroosmotic flow pump 70, and the structure of the electricity generating section 100 does not become complicated. Further, as compared with the conventional case in which the electroosmotic flow pump is provided such that it is exposed from the device such as the electricity generating section, it is possible to prevent damage caused by mechanical load which is caused by repeating the connection/disconnection between the electroosmotic flow pump 70 and the fuel cartridge 6 and it is possible to prevent deterioration of the electroosmotic flow pump 70 caused by contamination. Further, the electroosmotic flow pump 70 can be replaced by new one when the fuel cartridge 6 is replaced by new one. Therefore, it is possible to easily restore the output reduction caused by deterioration of the electroosmotic flow pump 70.

The liquid-suction material 78 is provided so as to extend over the inner wall surface 61a, the inner wall surface 61b and the inner wall surface 61c of the fuel storing section 61 from the fuel discharging section 63. Therefore, the wall surface 78b of the liquid-suction material 78 is always in contact with the fuel 10 irrespective of direction of the fuel cartridge 6 with respect to the gravity direction, the liquid-suction material 78 reliably absorbs the fuel 10, and the fuel 10 permeates the electroosmotic flow pump 70. The fuel 10 permeates the electroosmotic flow pump 70 by the capillary force, and the fuel 10 can reliably be sent from the fuel cartridge 6 by the output controlled from the electricity generating section 100.

The volume of the liquid-suction material 78 need not be large, and it is preferable because the volume of the fuel storing section 61 for the fuel 10 is not reduced so much. According to the third embodiment, it is not always necessary to use the end partition 12 as in the first and second embodiments.

### Fourth Embodiment

FIG. 5 is a side sectional view of a fuel cartridge 8 of a fourth embodiment taken along a longitudinal direction thereof. According to the fourth embodiment, like the third embodiment, the end partition 12 is not provided at the end of the fuel 10 in a fuel storing section 81, and a shape of a liquid-suction material 98 is different from that of the third embodiment.

The fuel cartridge 8 is for example, a square prism body having a hollow fuel storing section 81 and fuel 10 is stored in the fuel storing section 81. A fuel discharging section 83 is formed at a central position of a front surface 8a of the fuel cartridge 8 in its longitudinal direction. The fuel discharging section 83 penetrates the front surface 8a, and also penetrates a front surface 81a of the fuel storing section 81 corresponding to the former penetrating portion, the fuel discharging section 83 and the fuel storing section 81 are in communication with each other, and fuel 10 is discharged through the fuel discharging section 83.

The fuel discharging section 83 is formed with a fuel discharge opening 84 which is a through hole through which fuel 10 in the fuel storing section 81 is discharged out. An electroosmotic flow pump 90 is disposed in the fuel discharge opening 84, and the electroosmotic flow pump 90 includes an electroosmosis material 91. The electroosmosis material 91 is the same as the electroosmosis material 21 of the above-described first embodiment. The electroosmosis material 91 is formed at its both surfaces with electrodes 92 and 93. The electrodes 92 and 93 are respectively connected to electrode terminals 94 and 95 through wires 96 and 97. The electrode terminals 94 and 95 are formed on the front surface 8a of the fuel cartridge 8. The liquid-suction material 98 is provided in the fuel discharge opening 84 such that the liquid-suction material 98 comes into surface-contact with the electrode 92 of the electroosmosis material 91. The liquid-suction material 98 includes a disk portion 98a fitted into the fuel discharge opening 84, and a string 98b extending into the fuel storing section 81 from the disk portion 98a in a string form. The tip end 98c of the string 98b is long enough to reach an inner side back surface 81b of the fuel storing section 81. Since the liquid-suction material 98 has the string 98b having enough length, the string 98b follows and moves in the gravity direction irrespective of direction of the fuel cartridge 8 with respect to the gravity direction and thus, the fuel 10 is always in contact with the string 98b.

An outside air communication opening 85 is formed at a central position of the back surface 81b of the fuel storing section 81 in its longitudinal direction. The outside air communication opening 85 penetrates the back surface 81b, and also penetrates a back surface 8b of the fuel cartridge 8 corresponding to the former penetrating portion, thereby bringing the fuel storing section 81 into communication with outside air. A check valve 86 for preventing fuel 10 and air from discharging out unnecessarily from the fuel storing section 81 is fitted to the outside air communication opening 85. The same duckbill valve as the check valve 16 of the above-described first embodiment can be used as the check valve 86.

The check valve 86 is provided with a through hole 86a through which inside and outside of the fuel storing section 81 are in communication with each other. The communication hole 86a is designed such that the check valve 86 applies a force in a direction for closing the communication hole 86a around the communication hole 86a by an internal pressure of the fuel storing section 81. Therefore, fuel 10 does not leak unnecessarily from the fuel storing section 81 through the communication hole 86a. If an amount of the fuel 10 stored in the fuel storing section 81 is reduced in the fuel storing section 81, a negative pressure is generated. The communication hole 86a is designed such that air from outside of the fuel storing section 81 enters through the communication hole 86a so as to buffer a pressure difference between inside and outside of the fuel storing section 81 in accordance with the negative pressure.

Therefore, if the fuel cartridge 8 is connected to the device main body such as the above-described electricity generating section 100, the fuel 10 is absorbed by the liquid-suction material 98 and permeates the liquid-suction material 98 which is in contact with the fuel 10 and the liquid-suction material 98 is impregnated with fuel 10 by a capillary force. The fuel 10 which permeates the liquid-suction material 98 and is absorbed by the liquid-suction material 98 is also absorbed by the electroosmosis material 91 which is in contact with the fuel 10. If voltage having an appropriate direction is applied between the electrodes 92 and 93 in this state, the fuel 10 of the electroosmosis material 91 flows from the electrode 92 to the electrode 93, and the fuel 10 exudes to outside of the electroosmosis material 91 from the electrode 93. With this, flow of fuel 10 is generated, and the fuel 10 is sent to the electricity generating section 100. If the dielectric of the electroosmosis material 91 comes into contact with the fuel 10 and the dielectric is negatively charged and the fuel 10 is positively charged, voltage is applied so that potential of the electrode 92 becomes higher than that of the electrode 93. If the dielectric of the electroosmosis material 91 comes into contact with the fuel 10 and the dielectric is positively charged and the fuel 10 is negatively charged, voltage is applied so that potential of the electrode 93 becomes higher than that of the electrode 92. If fuel 10 is discharged from the fuel storing section 81, the volume of the fuel 10 in the fuel storing section 81 is reduced. With this reduction in volume, the pressure in the fuel storing section 81 is reduced, the check valve 86 is opened and air enters the fuel storing section 11 from the check valve 86. The pressure in the fuel storing section 81 is reduced in this manner and a case in which the fuel 10 is not easily sent from the fuel cartridge 8 is prevented.

The fuel cartridge 8 can be used for the electricity generating apparatus as in the first embodiment. In this case, the fuel cartridge 8 includes the electricity generating section 100 comprising the same elements as those of the first embodiment, the evaporator 101, the reformer 102, the carbon monoxide remover 103, the combustor 104, the electricity generating cell 105, the DC/DC converter 106, the secondary battery 107 and the controlling section 108. The structure and operation of the electricity generating section 100 are the same as those of the first embodiment and thus, explanation thereof will be omitted.

According to the fourth embodiment, the electroosmotic flow pump 90 is provided in the fuel cartridge 8 as in the first embodiment. Therefore, it is only necessary to provide the liquid-suction material 98 on the fuel discharging section 83 such that the liquid-suction material 98 is in surface-contact with the electrode 92 of the electroosmotic flow pump 90, and the structure of the electricity generating section 100 does not become complicated. Further, as compared with the conventional case in which the electroosmotic flow pump is provided such that it is exposed from the device such as the electricity generating section, it is possible to prevent damage caused by mechanical load which is caused by repeating the connection/disconnection between the electroosmotic flow pump 90 and the fuel cartridge 8 and it is possible to prevent deterioration of the electroosmotic flow pump 90 caused by contamination. Further, the electroosmotic flow pump 90 can be replaced by new one when the fuel cartridge 8 is replaced by new one. Therefore, it is possible to easily restore the output reduction caused by deterioration of the electroosmotic flow pump 90.

Further, the string 98b of the liquid-suction material 98 is extended in a form of a sufficiently long string such that the liquid-suction material 98 is always in contact with the fuel 10 in the fuel storing section 81 from the fuel discharging section 83. Even if the remaining amount of fuel 10 is reduced and the fuel 10 is moved so as to lean toward the gravity direction, since the string 98b of the liquid-suction material 98 which flexibly deforms is used, it leans toward the gravity direction like the fuel 10, and the liquid-suction material 98 can be in contact with the fuel 10. As a result, it is possible to reliably absorb the fuel 10 and the fuel 10 permeates the electroosmotic flow pump 90, the fuel 10 permeates the electroosmotic flow pump 90 by the capillary force, and the fuel 10 can reliably be sent out from the fuel cartridge 8 by output controlled from the electricity generating section 100.

It is preferable that since the volume of the string 98b need not be large and it is unnecessary to largely reduce the volume of the fuel 10 of the fuel storing section 81. According to the fourth embodiment, it is unnecessary to use the end partition 12 as in the first and second embodiments.

The present invention is not limited to the above-described embodiments, and the invention can appropriately be modified within a range not departing from its subject matter.

Although the reforming type fuel cell systems have been described in the first to fourth embodiment as the electricity generating apparatus having the fuel cartridge, the present invention is not limited to the reforming type fuel cell system, and the invention can also be applied to a direct type fuel cell system.

In the above-described first to fourth embodiments, the liquid is chemical fuel alone or the mixture between chemical fuel and water, but the liquid is not limited to this, and the invention can also be applied to, for example, a printer which prints with ink (e.g., ink-jet printer) as the electronic device using the liquid cartridge, and ink may be accommodated in the liquid cartridge.

In the electroosmotic flow pump, bubbles may be generated depending upon a condition such as driving voltage, but means for separating and discharging the generated bubbles may be incorporated in the liquid cartridge.

According to the present invention, it is possible to easily restore the output reduction caused by damage or deterioration of the electroosmotic flow pump. Further, it is possible to reliably send liquid irrespective of direction with respect to the gravity direction. The structure of the device such as the electricity generating section does not become complicated.

The entire disclosure of Japanese Patent Application No. 2006-267997 on Sep. 29, 2006 including specification, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A liquid cartridge, comprising:
a storing section to store liquid;
an electroosmosis material to send the liquid, which is provided in a discharging section through which the liquid in the storing section is discharged;
an electrode to drive the electroosmosis material; and
an end partition to partition the storing section at an end of the liquid so as to cover the end and to follow the end of the liquid.

2. The liquid cartridge according to claim 1, further comprising a carrying section to introduce gas introduced by an external pressurizing section into an opposite side of the end partition from the liquid in the storing section.

3. The liquid cartridge according to claim 2, wherein an introducing opening from which the gas is introduced into the carrying section is disposed on a same side as the discharging section.

4. A liquid cartridge, comprising:
a storing section to store liquid;
an electroosmosis material to send the liquid, which is provided in a discharging section through which the liquid in the storing section is discharged;
an electrode to drive the electroosmosis material; and
a liquid-suction material to introduce the liquid to the electroosmosis material, which is provided on an inner wall surface continuously such that the liquid is in contact with the liquid-suction material irrespective of direction of the storing section with respect to a gravity direction and on the discharging section such that the liquid-suction material is in contact with the electroosmosis material.

5. A liquid cartridge, comprising:
a storing section to store liquid;
an electroosmosis material to send the liquid, which is provided in a discharging section through which the liquid in the storing section is discharged;
an electrode to drive the electroosmosis material; and
a liquid-suction material to introduce the liquid to the electroosmosis material, which is provided over an entire inner wall surface of the storing section and on the discharging section such that the liquid-suction material is in contact with the electroosmosis material.

6. A liquid cartridge, comprising:
a storing section to store liquid;
an electroosmosis material to send the liquid, which is provided in a discharging section through which the liquid in the storing section is discharged;
an electrode to drive the electroosmosis material, and
a liquid-suction material to introduce the liquid to the electroosmosis material, which includes a deformable section deformable by gravity having a length extending from the discharging section to a distal end of an inner wall of the storing section and which is provided on the discharging section such that the liquid-suction material is in contact with the electroosmosis material.

7. The liquid cartridge according to claim 6, wherein the deformable section is a string.

8. The liquid cartridge according to claim 1, wherein the liquid is fuel.

9. An electricity generating apparatus comprising:
a liquid cartridge according to claim 1; and
an electricity generating section to generate electricity with the liquid supplied from the liquid cartridge.

10. An electronic device comprising:
an electricity generating apparatus according to claim 9; and
an electronic device main body which operates by electricity generated by the electricity generating apparatus.
